(19) United States
(12) Patent Application Publication
(10) Pub. No.: US 2025/0222298 A1
(43) Pub. Date: Jul. 10, 2025

(54) WEARABLE EXERCISE DEVICE

(71) Applicant: Samsung Electronics Co., Ltd., Suwon-si (KR)

(72) Inventors: Junghoon PARK, Suwon-si (KR); Donghyun KIM, Suwon-si (KR); Yongtae KIM, Suwon-si (KR); Gyowook SHIN, Suwon-si (KR); Minhyung LEE, Suwon-si (KR)

(21) Appl. No.: 18/978,610

(22) Filed: Dec. 12, 2024

Related U.S. Application Data
(63) Continuation of application No. PCT/KR2024/015951, filed on Oct. 21, 2024.

(30) Foreign Application Priority Data
Jan. 4, 2024 (KR) 10-2024-0001541

(51) Int. Cl. A63B 21/00; A63B 21/005

(52) U.S. Cl. CPC A63B 21/4007; A63B 21/0058; A63B 21/153; A63B 21/4011; A63B 21/4021; A63B 2209/08

(57) ABSTRACT

A wearable exercise device may include an actuator including a motor, a level guide shaft, a level guide body, and a spool, in which the level guide shaft is rotated by the motor, the level guide body is connected to the level guide shaft, and the spool is provided in parallel to the level guide shaft, a cable that is at least partially wound around the spool, a cable guide that is connected to the actuator, configured to guide a path of the cable, and may include a plurality of tube magnets in a ring shape, a cable magnet that is connected to the cable and capable of passing through the plurality of tube magnets, and a cable holder that is connected to the distal wearing member, supports the cable magnet, and configured to apply magnetic force to the cable magnet.

### CROSS-REFERENCE TO RELATED APPLICATION(S)

This application claims the priority benefit of PCT/KR2024/015951, filed Oct. 21, 2024, which claims prior to Korean Patent Application No. 10-2024-0001541 filed on Jan. 4, 2024, in the Korean Intellectual Property Office, the disclosures of which are hereby incorporated herein by reference in their entireties for all purposes.

### BACKGROUND

### 1. Field

One or more example embodiments relate to a wearable exercise device.

### 2. Description of Related Art

A user may perform various exercises while wearing a wearable exercise device. The user may strengthen a muscle(s) of the body by applying tension to a cable of the wearable exercise device.

### SUMMARY

According to an example aspect, there may be provided a wearable exercise device including a proximal wearing member to be worn on a proximal part of a user, a distal wearing member to be worn on a distal part of the user, an actuator including a motor, a level guide shaft, a level guide body, and a spool in which the motor is disposed in the proximal wearing member and configured to generate power, the level guide shaft is configured to be rotated by the motor, the level guide body is connected, directly or indirectly, to the level guide shaft, and the spool is provided in parallel to the level guide shaft, a cable that is at least partially wound around the spool and configured to transmit power generated from the actuator to the distal wearing member, a cable guide that is connected, directly or indirectly, to the actuator, configured to guide a path of the cable, and may include a plurality of tube magnets in a ring shape, a cable magnet that is connected, directly or indirectly, to the cable and capable of passing through the plurality of tube magnets, and a cable holder that is connected, directly or indirectly, to the distal wearing member, supports the cable magnet, and configured to apply magnetic force to the cable magnet. In an example embodiment, a position of the cable wound around the spool changes in a direction parallel to a rotation axis direction of the spool, and the cable may be provided to be bent in different directions a plurality of times.

According to another example aspect, there may be provided a wearable exercise device including a proximal wearing member worn on a proximal part of a user, a distal wearing member worn on a distal part of the user, an actuator including a motor, a level guide shaft, a level guide body, a spool, and a level guide groove, in which the motor is disposed in the proximal wearing member and configured to generate power, the level guide shaft is rotated by the motor, the level guide body is connected, directly or indirectly, to the level guide shaft, the spool is provided in parallel to the level guide shaft, and the level guide groove recessed from a surface of the level guide groove, and a cable that is at least partially wound around the spool and configured to transmit power generated from the actuator to the distal wearing member. A position of the cable wound around the spool changes in a direction parallel to a rotation axis direction of the spool, and the level guide body may move in a rotation axis direction of the level guide shaft along the level guide groove.

According to an example aspect, there may be provided a wearable exercise device including a proximal wearing member worn on a proximal part of a user, a distal wearing member worn on a distal part of the user, an actuator including a motor, a level guide shaft, and a level guide body, in which the motor is disposed in the proximal wearing member and configured to generate power, the level guide shaft is rotated by the motor, and the level guide body is connected, directly or indirectly, to the level guide shaft, a cable that is at least partially wound around the level guide body and configured to transmit power generated from the actuator to the distal wearing member, a plurality of tube magnets that is connected, directly or indirectly, to the proximal wearing member, is configured to guide a path of the cable, and has a ring shape, a cable guide that surrounds at least a portion of the cable and may include a cable tube where the plurality of tube magnets is disposed, and a cable magnet that is connected, directly or indirectly, to the cable and capable of passing through the plurality of tube magnets. In an embodiment, a gap between adjacent tube magnets among the plurality of tube magnets decreases as it gets closer to the distal wearing member based on a traveling direction of the cable.

According to an example aspect, there may be provided a wearable exercise device including a proximal wearing member worn on a proximal part of a user, a distal wearing member worn on a distal part of the user, an actuator including a motor, a level guide shaft, a level guide body, and a spool, in which the motor is disposed in the proximal wearing member and configured to generate power, the level guide shaft is rotated by the motor, the level guide body is connected, directly or indirectly, to the level guide shaft, and the spool is provided in parallel to the level guide shaft, a cable that is at least partially wound around the spool and configured to transmit power generated from the actuator to the distal wearing member, a cable magnet that is connected, directly or indirectly, to the cable, a holder body that supports the cable magnet and is connected, directly or indirectly, to the distal wearing member, a holder head that extends from the holder body and is configured to seat the cable magnet, a holder groove that is recessed in the holder head and passable by the cable, and a holder magnet that is disposed in the holder head and configured to apply magnetic force to the cable magnet.

According to an example aspect, there may be provided a wearable exercise device including a proximal wearing member worn on a proximal part of a user, a distal wearing member worn on a distal part of the user, an actuator including a motor, a level guide shaft, a level guide body, and a spool, in which the motor is disposed in the proximal wearing member and configured to generate power, the level guide shaft is rotated by the motor, the level guide body is connected to the level guide shaft, and the spool is provided in parallel to the level guide shaft, a cable that is at least partially wound around the spool and configured to transmit power generated from the actuator to the distal wearing member, and a cable tube that is connected to the proximal wearing member, is configured to guide a path of the cable, and surrounds at least a portion of the cable, and a cable guide including a cable chain configured to form a path of the cable tube. In an embodiment, the cable chain may include a pair of rotation links and a link bearing configured to connect the pair of rotation links, in which the pair of rotation links are rotatable around each other, and the cable is provided to be bent in different directions a plurality of times.

### BRIEF DESCRIPTION OF THE DRAWINGS

FIG. 1 is a schematic perspective view of a user wearing a wearable exercise device according to an example embodiment.

FIG. 2 is a schematic front view of the user wearing the wearable exercise device according to an example embodiment.

FIG. 3 is a perspective view of a cable guide according to an example embodiment.

FIG. 4 is a cross-sectional view of a connector according to an example embodiment.

FIG. 5 is a perspective view of an extension link according to an example embodiment.

FIG. 6 is a perspective view of a rotation link according to an example embodiment.

FIG. 7 is a cross-sectional view of a side surface of an end cover according to an example embodiment.

FIG. 8 is a front view of a ring part according to an example embodiment.

FIG. 9 is a cross-sectional view of a friction reduction member cut along the cutting line IX-IX of FIG. 8.

FIG. 10 is a side view of the inside of an actuator according to an example embodiment.

FIG. 11 is another side view of the inside of the actuator according to an example embodiment.

FIG. 12 is a cross-sectional view of a screw according to an example embodiment.

FIG. 13 is a schematic side view of a plurality of tube magnets and a cable magnet according to an example embodiment.

FIG. 14 is a perspective view of a cable holder and the cable magnet according to an example embodiment.

### DETAILED DESCRIPTION

The following detailed structural or functional description is provided as an example only and various alterations and modifications may be made to certain example embodiments. Accordingly, the example embodiments are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component.

It should be noted that if it is described that one component is “connected”, “coupled”, or “joined” to another component, at least a third component(s) may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

The term “on” as used herein covers both directly and indirectly on.

The same name may be used to describe an element included in the example embodiments described above and an element having a common function. Unless otherwise mentioned, the descriptions of the example embodiments may be applicable to the following example embodiments, and thus duplicated descriptions will be omitted for conciseness.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

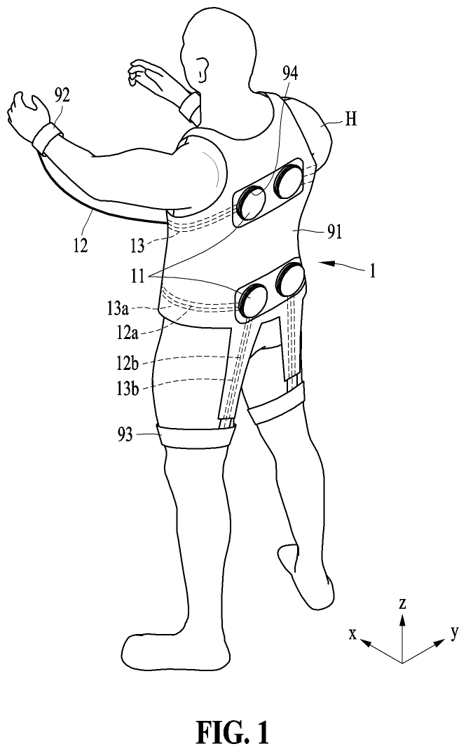

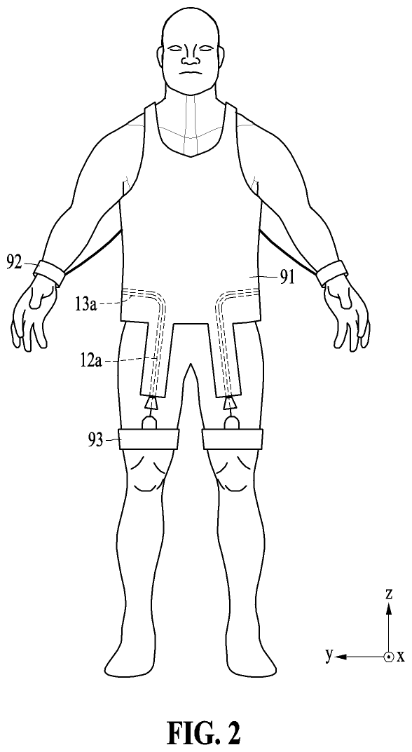

FIG. 1 is a schematic perspective view of a user wearing a wearable exercise device according to an embodiment. FIG. 2 is a schematic front view of the user wearing the wearable exercise device according to an embodiment.

Referring to FIGS. 1 and 2, a wearable exercise device 1, according to an embodiment, may assist the exercise or walking of a user H by using the tension of a cable 12. The user H may be a person. It should also be noted that the user H may be an animal. The wearable exercise device 1 may include a proximal wearing member 91 comprising a support that is worn on a body part of the user H, an actuator 11 readily attachable to or detachable from the proximal wearing member 91, at least one cable 12 that receives power from the actuator 11 and transmits the received power to another body part of the user H, a first distal wearing member 92 that is worn on a first part of the user H, a distal wearing member 93 that is worn on a second part of the user H, and a cable guide 13 that is connected, directly or indirectly, to the actuator 11 and guides a path of the cable 12. Each distal wearing member 92 may comprise a support, such as for supporting a cable 12 directly or indirectly.

In an embodiment, the proximal wearing member 91 may be worn on a proximal part of the user H. It should be noted that a position at which the proximal wearing member 91 is worn is not limited thereto. For example, the proximal wearing member 91 may be disposed on the lower body of the user H, the upper arm of the user H, the lower arm of the user H, or the foot of the user H. The proximal wearing member 91 may be produced to have a shape suitable for the body part on which the proximal wearing member 91 is worn.

In an embodiment, the proximal wearing member 91 may include a support for supporting a plurality of wearing stations 94. The wearing stations 94 refers to regions where the actuator 11 is mounted. For example, the wearing stations 94 may be recessed inside the proximal wearing member 91. In this case, the inside of the proximal wearing member 91 is a surface facing the user H's body. The wearing stations 94 may be provided with a fixing member (not shown) for fixing the actuator 11. For example, the actuator 11 may be screwed to the wearing stations 94. For another example, the actuator 11 may be attached to the wearing stations 94. The wearing stations 94 may be provided with a Velcro structure. In an embodiment, the actuator 11 may be a modular actuator 11 attachably or detachably connected, directly or indirectly, to the wearing stations 94. The plurality of wearing stations 94 is illustrated as four on the back, but their number and their position are not limited thereto.

In an embodiment, a first part and a second part to which the distal wearing member 92 is attached may be different from parts to which the proximal wearing member 91 is attached. The first part and the second part may be distal parts. For example, the first part of the user H may be a wrist of the user H. For example, the second part of the user H may be a thigh of the user H. It should be noted that the positions of the first part and the second part are not limited thereto.

In an embodiment, the wearable exercise device 1 may include any one of the first distal wearing member 92 and the second distal wearing member 93. For example, the wearable exercise device 1 may include only the first distal wearing member 92 that is worn on the wrist to assist the upper body exercise of the user H. In this case, the proximal wearing member 91 may have a vest-like shape that is worn on the upper body of the user H and surrounds the chest. For another example, the wearable exercise device 1 may include only the second distal wearing member 93 that is worn on the thigh to assist the lower body exercise of the user H. In this case, the proximal wearing member 91 may have a belt-like shape that is worn on the waist of the user H. Hereinafter, for ease of description, the wearable exercise device 1 including the distal wearing member 93 that is worn on the thigh of the user H and the cable 12 connected, directly or indirectly, to the distal wearing member 93 is mainly described.

In an embodiment, the cable 12 may transmit power generated by the actuator 11 to the distal wearing member 93. For example, the cable 12 may not be elastic. In this case, the cable 12 may transmit most of power output from the actuator 11 to the body of the user H. For another example, the cable 12 may be elastic. In this case, the cable 12 may absorb some of the power output from the actuator 11.

In an embodiment, a plurality of cables 12 may receive power from one actuator 11 and may transmit the received power to one distal wearing member 93. One actuator 11 may control the tension of the plurality of cables 12. For example, when two cables 12 are provided, one may be referred to as a front cable 12a and the other may be referred to as a rear cable 12b. The front cable 12a may extend from the actuator 11, may pass through a cable guide 13a, and then, may be connected, directly or indirectly, to the front of the distal wearing member 93. The rear cable 12b may extend from the actuator 11, may pass through a cable guide 13b, and then, may be connected, directly or indirectly, to the rear of the distal wearing member 93.

In an embodiment, a travel path of the cable 12 may be guided by the cable guide 13. One cable 12 may pass through one cable guide 13. The cable 12 extending from the actuator 11 may enter inside the cable guide 13, and then may pass through the cable guide 13 to be connected, directly or indirectly, to the distal wearing member 93. The cable guide 13 may protect the cable 12 from external shock. In an embodiment, considering appearance, the cable guide 13 may be at least partially covered by the proximal wearing member 91.

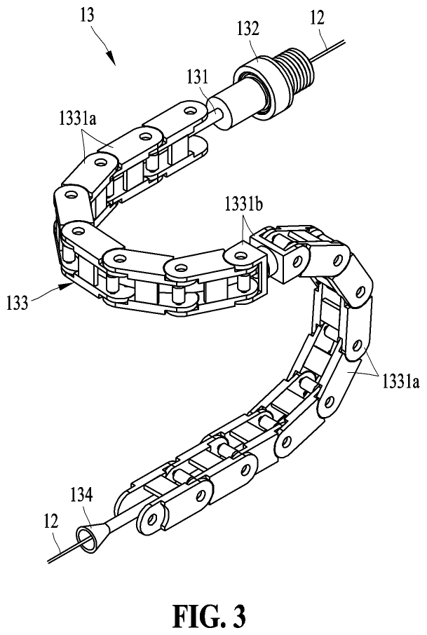

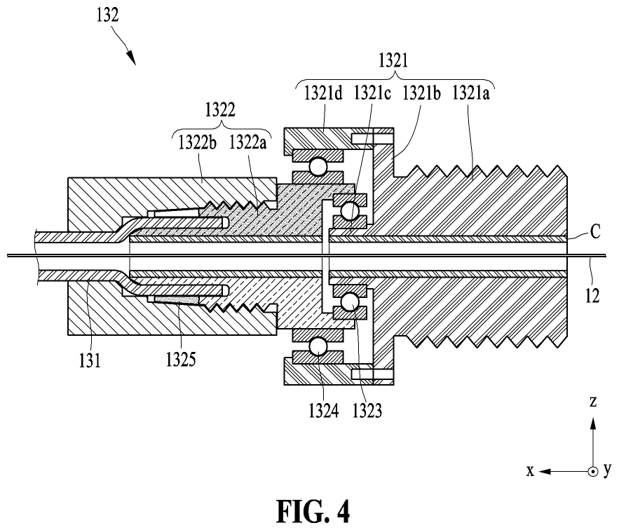

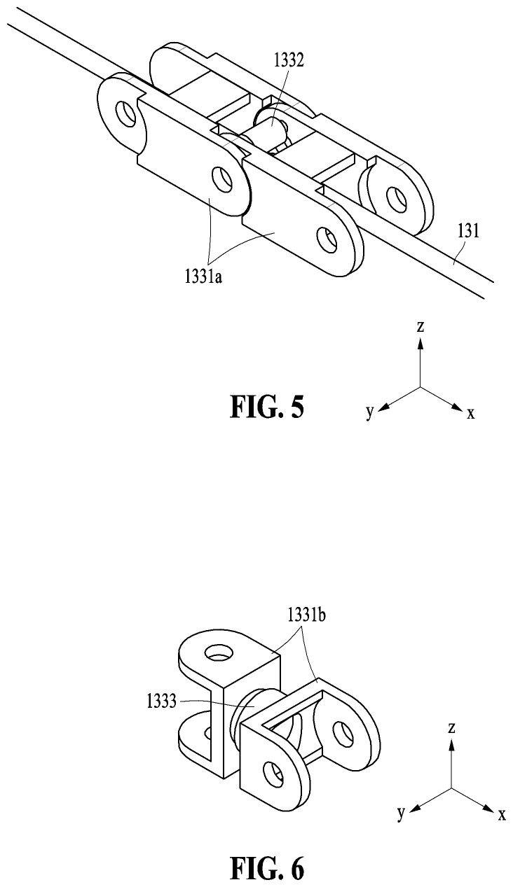

FIG. 3 is a perspective view of a cable guide according to an embodiment, and FIG. 4 is a cross-sectional view of a connector according to an embodiment. FIG. 5 is a perspective view of an extension link according to an embodiment, and FIG. 6 is a perspective view of a rotation link according to an embodiment.

Referring to FIGS. 3 to 6, the cable guide 13, according to an embodiment, may include a cable tube 131, a connector 132, a cable chain 133, and an end cover 134. The connector 132 may be connected, directly or indirectly, to one end of the cable tube 131, and the end cover 134 may be connected, directly or indirectly, to the other end of the cable tube 131.

In an embodiment, the cable tube 131 may cover the cable 12. The cable 12 may move relative to the cable tube 131 inside the cable tube 131. To reduce the friction between the cable 12 and the cable tube 131, the cable tube 131 may be formed of a material having a relatively flexible and smooth surface. For example, the cable tube 131 may be formed of a thermoplastic polyurethanes (TPU) material. The damage and wear of the cable 12 due to the friction between the cable 12 and the cable tube 131 may be reduced.

In an embodiment, the cable tube 131 may be connected, directly or indirectly, to an actuator (e.g., the actuator 11 of FIG. 1) through the connector 132. The inside of the cable tube 131 may communicate with the inside of the actuator. The connector 132 may include a fixed part 1321, a rotating part 1322, an inner bearing 1323, and an outer bearing 1324.

In an embodiment, the fixed part 1321 may be connected, directly or indirectly, to the actuator. For example, the fixed part 1321 may be directly connected to the actuator through a fixed body 1321a where threads are formed. However, it should be noted that a means of connection between the fixed part 1321 and the actuator is not limited thereto. The fixed part 1321 may include the fixed body 1321a that is connected to the actuator, a base plate 1321b of which the center is penetrated and has a circular shape, and an inner wall 1321c and an outer wall 1321d that extend from the base plate 1321b. The inner wall 1321c may extend in a vertical direction from an inner edge of the base plate 1321b. The outer wall 1321d may extend in a vertical direction from an outer edge of the base plate 1321b. The cable 12 may pass through the penetrated center of the base plate 1321b, and then may reach the rotating part 1322.

In an embodiment, the rotating part 1322 may connect one end of the cable tube 131 to the fixed part 1321. The rotating part 1322 may include a rotating body 1322a that is rotatably connected, directly or indirectly, to the fixed part 1321 and a rotating head 1322b that is connected, directly or indirectly, to the rotating body 1322a. After inserting one end of the rotating body 1322a into the inside of one end of the cable tube 131 and disposing a packing 1325 on the outside of the end of the cable tube 131, the rotating body 1322a and the rotating head 1322b may be connected, directly or indirectly, to fix the cable tube 131 to the rotating part 1322. For example, the rotating head 1322b may be screwed to threads formed on the surface of the rotating body 1322a. In this case, the packing 1325 may be formed of an elastic material, like rubber.

In an embodiment, the rotating part 1322 may be rotatably connected, directly or indirectly, to the fixed part 1321. The other end of the rotating body 1322a may be connected, directly or indirectly, to the fixed part 1321 through the inner bearing 1323 and the outer bearing 1324. The inner bearing 1323 may be supported by the inner wall 1321c, and the outer bearing 1324 may be supported by the outer wall 1321d. The diameter of the outer bearing 1324 may be greater than the diameter of the inner bearing 1323. The rotating part 1322 may be supported by the inner bearing 1323 and the outer bearing 1324 and may rotate relative to the fixed part 1321. The rotation axis of the rotating part 1322 may be parallel to a longitudinal direction of the rotating part 1322. In this structure, the degree of freedom of the cable tube 131 with respect to a proximal wearing member may increase.

In an embodiment, to reduce the friction between the cable 12 and the connector 132, a TPU coating layer C may be disposed on the surface of the rotating body 1322a, the inner wall 1321c, and the fixed body 1321a exposed to a path through which the cable 12 travels.

The cable chain 133, according to an embodiment, may include a plurality of chain links 1331a and 1331b connected to each other. The cable tube 131 may extend inside the chain links 1331a and 1331b. Either one of the chain links 1331a and 1331b may be rotatably connected to the adjacent chain link 1331b or 1331a. In this structure, the cable chain 133 may form the path of the cable tube 131. The chain links 1331a and 1331b may be provided in a plurality of types having different structures to guide a traveling direction of the cable tube 131. In this case, the traveling direction of the cable 12 refers to the traveling direction of the cable 12 toward a distal wearing member inside the cable tube 131.

In an embodiment, the chain link 1331a may guide the path of the cable tube 131 to travel only on the same plane. In this case, the chain link 1331a may also be referred to as an extension link. Based on FIG. 5, the extension link 1331a may be connected such that the extension link 1331a may rotate (pitch-rotate) with a y-axis as a rotation axis with respect to the extension link 1331a having been disposed in advance. Based on FIG. 5, the traveling direction of the cable tube 131 may be guided in a rotation direction around the y-axis by the extension link 1331a.

In an embodiment, a pair of rollers 1332 may be disposed inside the extension link 1331a. For example, the pair of rollers 1332 may be disposed at a point where two adjacent extension links 133 1a are connected. A rotation axis of the pair of rollers 1332 may be parallel to the rotation axis of the extension link 1331a. The cable tube 131 may pass through between the pair of rollers 1332 and may be supported by each of the rollers 1332. In this structure, the friction between the cable tube 131 and the cable chain 133 may be reduced. Meanwhile, it should be noted that a position where the pair of rollers 1332 is disposed within the extension link 1331a is not necessarily limited thereto.

In an embodiment, the chain link 1331b may change a travel path of the cable tube 131, which may extend only on the same plane, to another plane. In this case, the chain link 1331b may also be referred to as the rotation link 1331b. As illustrated in FIG. 3, a pair of interconnected rotation links 1331b may be disposed between a plurality of interconnected extension links 1331a.

In an embodiment, one end of the rotation link 1331b has the same structure as that of one end of the extension link 1331a and may be connected to the extension link 1331a. The surfaces of the rotation links 1331b facing each other may be connected to each other through a link bearing 1333. The diameter of the link bearing 1333 may be greater than the diameter of the cable tube 131 such that the cable tube 131 may pass through the link bearing 1333. Based on FIG. 6, the pair of rotation links 1331b may rotate (roll-rotate) with an x-axis as a rotation axis with respect to each other through the link bearing 1333. Each of a plurality of extension links 1331a connected to the pair of rotation links 1331b may rotate around the link bearing 1333 with respect to each other. The pair of rotation links 1331b is disposed such that the cable tube 131 and the cable 12 may be provided to be bent in different directions a plurality of times. For example, as illustrated in FIG. 2, the front cable 12a extending from a user's back, wrapping the user's waist, may be bent downward from the user's abdomen and may extend along the user's thigh.

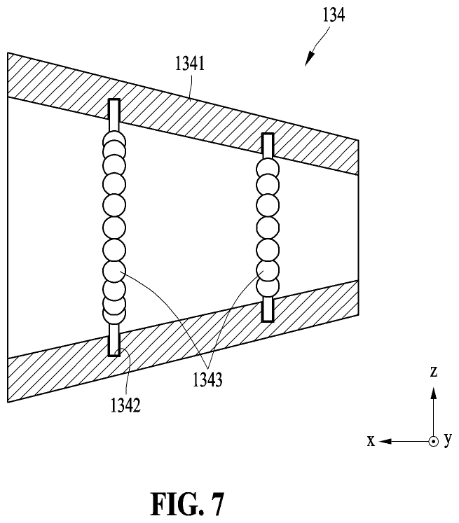

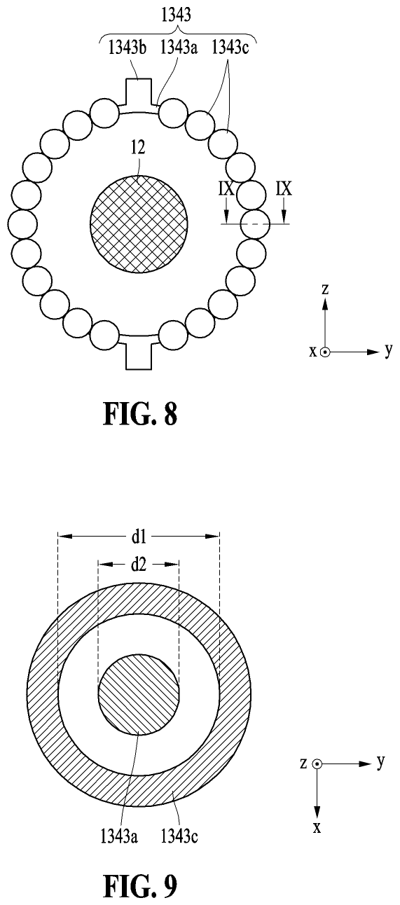

FIG. 7 is a cross-sectional view of a side surface of an end cover according to an embodiment, FIG. 8 is a front view of a ring part according to an embodiment, and FIG. 9 is a cross-sectional view of a friction reduction member cut along the cutting line IX-IX of FIG. 8.

Referring to FIGS. 7 to 9, the end cover 134, according to an embodiment, may cover at least a portion of the cable 12 getting out of a cable tube (e.g., the cable tube 131 of FIG. 3). The end cover 134 may include a cover body 1341 and at least one ring part 1343.

In an embodiment, the cover body 1341 may be connected to an end of the cable tube. The cover body 1341 may be formed of, for example, a polyoxymethylene (POM) material. The cover body 1341 may have a tapered structure whose cross-sectional area increases as away from the cable tube along the traveling direction of the cable 12. In this structure, a sufficient range within which the cable 12 getting out of the cable tube may move in a direction intersecting the traveling direction may be secured.

In an embodiment, the ring part 1343 is disposed in the inner side of the cover body 1341 and may reduce the friction between the cable 12 and the cover body 1341. In an embodiment, there may be a plurality of ring parts 1343 arranged side by side. The ring part 1343 may include a ring base 1343a, a ring protrusion 1343b, and a plurality of friction reduction members 1343c.

In an embodiment, the ring base 1343a may have a ring shape. The ring protrusion 1343b may extend in a radial direction from the ring base 1343a. The ring protrusion 1343b may be accommodated by a cover groove 1342 formed in the inner side of the cover body 1341. For example, there may be a plurality of ring protrusions 1343b spaced apart from one another along the circumference of the ring base 1343a. With the ring protrusion 1343b of the ring part 1343 accommodated by the cover groove 1342, the ring part 1343 may be fixed to the cover body 1341.

In an embodiment, the plurality of friction reduction members 1343c may be penetrated by the ring base 1343a and may be connected, directly or indirectly, to the ring base 1343a. The friction reduction member 1343c may be spaced apart from the cover body 1341. The ring base 1343a may penetrate the friction reduction member 1343c in a curved line rather than a straight line. Based on the cross-section, a diameter d1 of a hole of the friction reduction member 1343c penetrated by the ring base 1343a may be greater than a thickness d2 of the ring base 1343a such that the friction reduction member 1343c may rotate with respect to the ring base 1343a. When the cable 12 contacts the friction reduction member 1343c, the friction reduction member 1343c rotates with respect to the ring base 1343a while being swept by the cable 12, and the friction between the cover body 1341 and the cable 12 may be reduced.

In an embodiment, based on the cross-section viewed from the traveling direction of the cable 12, the size of the friction reduction member 1343c may be less than the diameter of the cable 12. In this structure, the cable 12 may pass through the ring part 1343 without being caught between two adjacent friction reduction members 1343c. Meanwhile, it should be noted that the shape of the friction reduction member 1343c may vary. For example, the friction reduction member 1343c may have a roller shape rather than a ball shape.

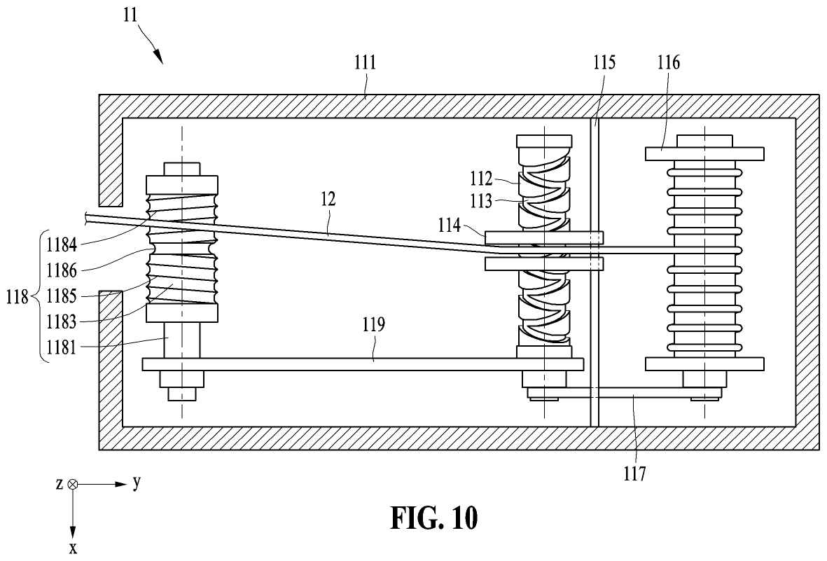

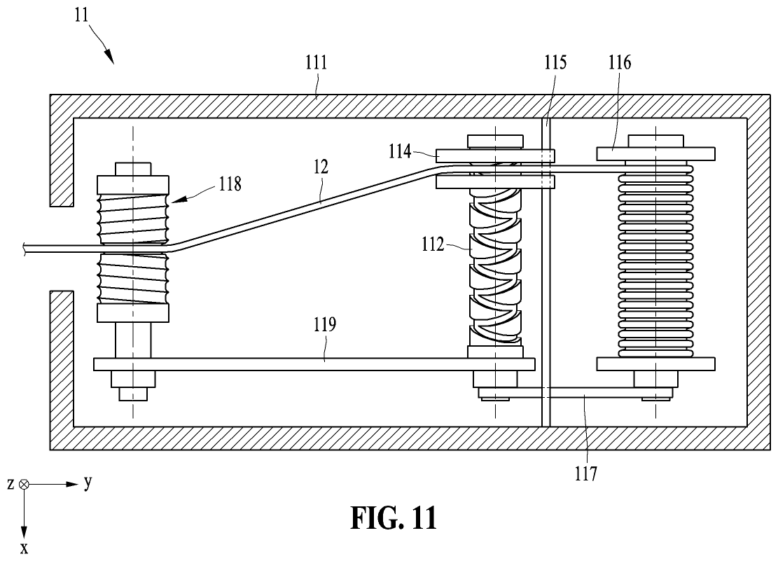

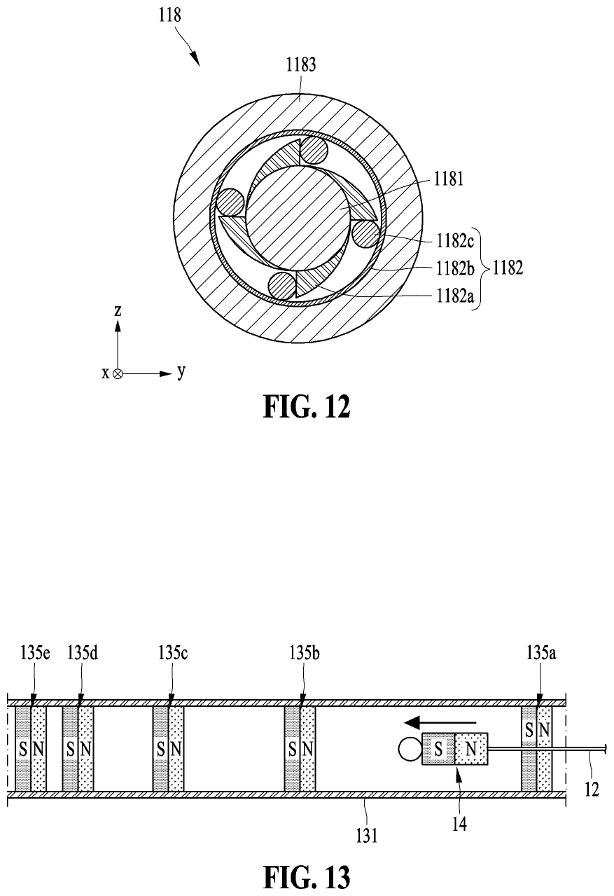

FIGS. 10 and 11 each are a side view of the inside of an actuator according to an embodiment, and FIG. 12 is a cross-sectional view of a screw according to an embodiment.

Referring to FIGS. 10 to 12, the actuator 11, according to an embodiment, may uniformly wind the cable 12 and may maintain the cable 12 extending from the inside of the actuator 11 to the outside of the actuator 11 at a uniform height. In this case, the height of the cable 12 is a distance to the cable 12 measured based on the bottom surface of a housing 111. The actuator 11 may include the housing 111, a level guide shaft 112, a level guide body 114, a spool 116, and a screw 118.

In an embodiment, the housing 111 may surround a motor (not shown), a reducer (not shown), the level guide shaft 112, the level guide body 114, the spool 116, and the screw 118. One end of the cable 12 may be fixed to the spool 116. The spool 116 rotates in one direction or the other direction opposite to the direction such that at least a portion of the cable 12 may be wound around or unwound from the spool 116. The position of the cable 12 wound around the spool 116 may be changed to a direction parallel to a rotation axis direction of the spool 116 by the level guide shaft 112 and the level guide body 114.

In an embodiment, the level guide shaft 112 may be provided in parallel to the spool 116. The level guide shaft 112 is connected to the spool 116 through a first pulley belt 117 and may rotate with the spool 116 by receiving power from the motor. The rotation axis of the level guide shaft 112 may be parallel to a longitudinal direction of the level guide shaft 112 and may be parallel to a rotation axis of the spool 116.

In an embodiment, the level guide body 114 may be connected, directly or indirectly, to the level guide shaft 112. The center of the level guide body 114 may be penetrated by the level guide shaft 112. The level guide body 114 may support each of the upper and lower sides of the cable 12. In this structure, when the level guide body 114 moves upward and downward on the level guide shaft 112, the portion of the cable 12 supported by the level guide body 114 may move upward and downward. In this case, the upward and downward directions are parallel to the longitudinal direction of the level guide shaft 112.

In an embodiment, a portion of the level guide body 114 may be movably connected, directly or indirectly, to a support bar 115 fixed inside the housing 111. For example, the support bar 115 may penetrate the level guide body 114. The level guide body 114 is tied to the support bar 115 such that the level guide shaft 112 may rotate relative to the level guide body 114. When the level guide shaft 112 rotates, the level guide body 114 may move upward and downward along the level guide groove 113 recessed from a surface of the level guide shaft 112.

In an embodiment, the level guide body 114 may be connected to the level guide shaft 112 through at least a guide protrusion (not shown). The guide protrusion may be provided inside the level guide body 114 facing the level guide shaft 112. The guide protrusion may be accommodated by the level guide groove 113 formed on the surface of the level guide shaft 112. The guide protrusion may rotate in a direction protruding from the level guide body 114 as a rotation axis.

In an embodiment, the level guide groove 113 may have a diamond pattern shape. When the level guide shaft 112 rotates, a diagonal direction (e.g., upward to the right) of the level guide groove 113 that guides the level guide body 114 to the upper side may be different from a diagonal direction (e.g., downward to the right) of the level guide groove 113 that guides the level guide body 114 to the lower side. For example, the guide protrusion is accommodated by the level guide groove 113 formed upwardly to the right and the level guide shaft 112 rotates in one direction such that the level guide body 114 may reach an upper end of the level guide shaft 112. Then, the guide protrusion may rotate with respect to the level guide body 114 such that the guide protrusion may be accommodated by the level guide groove 113 formed downward to the right along an upper boundary of the level guide groove 113 leading from upward to the right to downward to the right. The guide protrusion is accommodated by the level guide groove 113 formed downward to the right and the level guide shaft 112 rotates in one direction such that the level guide body 114 may reach a lower end of the level guide shaft 112. Then, the guide protrusion may be accommodated by the level guide groove 113 formed upwardly to the right along a lower boundary of the level guide groove 113 leading from downward to the right to upward to the right.

In this mechanism, when the level guide shaft 112 continuously rotates in one direction or its opposite direction, the level guide body 114 may reciprocate in a direction parallel to a rotation axis direction of the level guide shaft 112. The level guide body 114 moves along the level guide groove 113 such that the height of the cable 12 wound around the spool 116 may be changed, and the cable 12 may be uniformly wound around the spool 116. The tangle and wear of the cable 12 may be reduced.

In an embodiment, at least a portion of the cable 12 extending from the level guide body 114 to the outside of the housing 111 may contact the screw 118. The screw 118 may maintain the cable 12 getting out of the housing 111 at a uniform height. The screw 118 may include a screw shaft 1181, a clutch 1182, a screw body 1183, an upper thread 1184, a lower thread 1185, and a core groove 1186.

In an embodiment, the screw shaft 1181 may be parallel to the level guide shaft 112. The screw shaft 1181 may rotate by receiving power from the level guide shaft 112. For example, the screw shaft 1181 and the level guide shaft 112 may be connected to each other through a second pulley belt 119. A rotation axis of the screw axis/shaft 1181 may be parallel to the rotation axis of the level guide axis/shaft 112.

In an embodiment, the clutch 1182 surrounds the screw shaft 1181 and may transmit power in only one direction around the screw shaft 1181. The clutch 1182 may be a one-way clutch. In an embodiment, the clutch 1182 may include an inner race 1182a, an outer race 1182b, and a rolling element 1182c. The inner race 1182a may have a structure having a plurality of protrusions along a circumference around a rotation axis whose protruding height increases as it gets further away from the rotation axis. When the inner race 1182a rotates in any one direction (e.g., a clockwise direction of FIG. 12) with respect to the outer race 1182b, the rolling element 1182c rolls with respect to the outer race 1182b such that the inner race 1182a may rotate with respect to the outer race 1182b. In this case, power may not be transmitted from the inner race 1182a to the outer race 1182b. On the contrary, the inner race 1182a rotates in a direction (e.g., a counterclockwise direction of FIG. 12) opposite to the direction with respect to the outer race 1182b, a distance between the inner race 1182a and the outer race 1182b, facing any rolling element 1182c, may decrease, and the rolling element 1182c may be between the inner race 1182a and the outer race 1182b. In this case, the outer race 1182b rotates with the inner race 1182a, and power may be transmitted from the inner race 1182a to the outer race 1182b. It should be noted that the rolling element 1182c may have various shapes, like a ball, a roller, or a sprag.

In an embodiment, the screw body 1183 may surround the clutch 1182. The screw body 1183 may rotate by receiving power in only one direction from the outer race 1182b of the clutch 1182.

In an embodiment, the upper thread 1184, the lower thread 1185, and the core groove 1186 may be formed on a surface of the screw body 1183. The core groove 1186 is recessed from the surface of the screw body 1183 and may be formed between the upper thread 1184 and the lower thread 1185. For example, based on a longitudinal direction of the screw body 1183, a height at which the lower thread 1185 is formed may be the same as a height at which the upper thread 1184 is formed. The cable 12 seated in the core groove 1186 may move in a direction intersecting a rotation axis of the screw body 1183. For example, the cable 12 seated in the core groove 1186 moves in a direction perpendicular to the rotation axis of the screw body 1183, and the whole cable 12 may travel in a direction parallel to the bottom surface of the housing 111.

In an embodiment, the upper thread 1184 and the lower thread 1185 may guide the cable 12 to be seated in the core groove 1186. The directions in which the upper thread 1184 and the lower thread 1185 are formed may be opposite to each other. For example, as illustrated in FIG. 12, when the inner race 1182a rotates in a counterclockwise direction with respect to the outer race 1182b such that power is transmitted to the outer race 1182b, the upper thread 1184 may be formed as a right screw, and the lower thread 1185 may be formed as a left screw. In this structure, the screw body 1183 rotates in only a counterclockwise direction by receiving power from the clutch 1182, and the upper thread 1184 and the lower thread 1185 may always guide the cable 12 to the core groove 1186. For example, when the cable 12 is seated in the upper thread 1184, the screw body 1183 rotates in a counterclockwise direction such that the cable 12 may be seated in the core groove 1186 along the upper thread 1184. For another example, when the cable 12 is seated in the lower thread 1185, the screw body 1183 rotates in a counterclockwise direction such that the cable 12 may be seated in the core groove 1186 along the lower thread 1185. Even if the cable 12 temporarily deviates from the screw 118, the cable 12 contacts the screw 118 again, and then may remain seated in the core groove 1186. Friction acting on the cable 12 entering a fixed body (e.g., the fixed body 1321a of FIG. 4) of a cable guide from the actuator 11 may be reduced.

FIG. 13 is a schematic side view of a plurality of tube magnets and a cable magnet according to an embodiment.

Referring to FIG. 13, a plurality of tube magnets 135a, 135b, 135c, 135d, and 135e having a ring shape are disposed inside the cable tube 131, according to an embodiment, and a cable magnet 14 may be connected to the other end of the cable 12. For example, the cable magnet 14 may have a ring shape penetrating the cable 12. Due to a knot formed at an end of the cable 12, the cable magnet 14 may not be separated from the cable 12. The other end of the cable 12 enters inside the cable tube 131 through a connector (e.g., the connector 132 of FIG. 3), passes through the cable tube 131 through magnetic force between the plurality of tube magnets 135a, 135b, 135c, 135d, and 135e and the cable magnet 14, and then, may be connected to a distal wearing member (e.g., the distal wearing member 93 of FIG. 1).

In an embodiment, the plurality of tube magnets 135a, 135b, 135c, 135d, and 135e may be provided. In the cable tube 131, a gap between adjacent tube magnets among the plurality of tube magnets 135a, 135b, 135c, 135d, and 135e may decrease as it gets closer to the distal wearing member based on a traveling direction of the cable 12. For example, FIG. 13 illustrates five tube magnets 135a, 135b, 135c, 135d, and 135e, which may be referred to as the first tube magnet 135a, the second tube magnet 135b, the third tube magnet 135c, the fourth tube magnet 135d, and the fifth tube magnet 135e sequentially based on the traveling direction of the cable 12.

In an embodiment, when the cable 12 gets closer to the cable tube 131, the first tube magnet 135a applies magnetic force to the cable magnet 14, and the cable magnet 14 and the cable 12 may move in the traveling direction inside the cable tube 131. The cable 12 moves in the traveling direction, and the cable magnet 14 may reach between the first tube magnet 135a and the second tube magnet 135b. In this case, the magnetic force applied to the cable magnet 14 by the second tube magnet 135b to the fifth tube magnet 135e may be greater than the magnetic force applied to the cable magnet 14 by the first tube magnet 135a. The cable magnet 14 moves toward the second tube magnet 135b by magnetic force, and the cable 12 may move in the traveling direction. The cable 12 moves in the traveling direction, and the cable magnet 14 may reach between the second tube magnet 135b and the third tube magnet 135c. In this case, the magnetic force applied to the cable magnet 14 by the third tube magnet 135c to the fifth tube magnet 135e may be greater than the magnetic force applied to the cable magnet 14 by the first tube magnet 135a and the second tube magnet 135b. The cable magnet 14 moves toward the third tube magnet 135c by magnetic force, and the cable 12 may move in the traveling direction. Through this process, the cable magnet 14 that has passed through the first tube magnet 135a may pass through the fifth tube magnet 135e only by magnetic force and may get out of the cable tube 131. The process of the cable 12 passing through the cable tube 131 may be simplified.

It has been described that the number of tube magnets 135a, 135b, 135c, 135d, and 135e are five, but it should be noted that the number of tube magnets disposed in the cable tube 131 may be less than or greater than five.

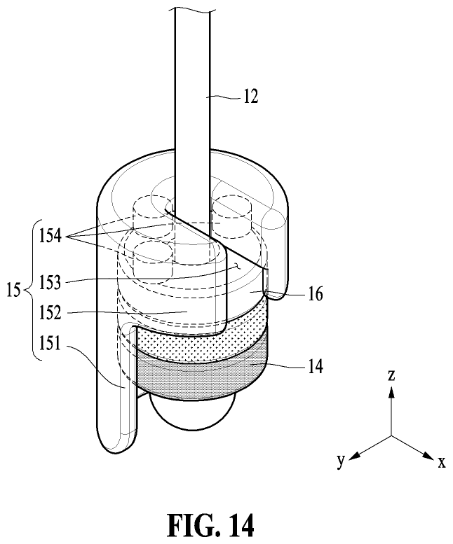

FIG. 14 is a perspective view of a cable holder and the cable magnet according to an embodiment.

Referring to FIG. 14, the cable 12, according to an embodiment, may be connected to a distal wearing member (e.g., the distal wearing member 93 of FIG. 1) through the cable holder 15. The cable holder 15 supports the cable magnet 14 and may apply magnetic force to the cable magnet 14. The distal wearing member and the cable 12 may be connected through a locking structure and magnetic force. The connection structure and connection process between the distal wearing member and the cable 12 may be simplified. The cable holder 15 may include a holder body 151, a holder head 152, a holder groove 153, and a holder magnet 154.

In an embodiment, the holder body 151 may be connected to the distal wearing member. For example, a lower part of the holder body 151 may extend further downward to form a ring (not shown), and the distal wearing member may be connected to the ring of the holder body 151. Based on FIG. 14, a downward direction is a-z direction.

In an embodiment, the holder head 152 extends from the holder body 151 and may cover at least a portion of the cable magnet 14. The holder head 152 may have a cup shape with seating space therein.

In an embodiment, the holder groove 153 may be recessed from the holder head 152. The holder groove 153 is recessed from the outside toward the center of the holder head 152 and may communicate with the seating space of the holder head 152. After the cable 12 passes through the holder groove 153 and is aligned with the center of the holder head 152, when the cable 12 is pulled in a direction away from the distal wearing member, the cable magnet 14 may get closer to the holder head 152. When the cable magnet 14 reaches a specific position, the magnetic force of the holder magnet 154 disposed inside the holder head 152 may act on the cable magnet 14. The cable magnet 14 is seated in the seating space by magnetic force and may remain supported by the holder head 152. Meanwhile, it should be noted that the holder magnet 154 may be disposed on a side of the holder head 152 facing the cable magnet 14.

In an embodiment, a cap 16 may be additionally connected to the cable 12. The cap 16 may be formed of, for example, an elastic material, like rubber. The cap 16 may be positioned between the holder head 152 and the cable magnet 14. The cap 16 may directly contact the holder head 152 instead of the cable magnet 14. When great force is applied to the cable 12 due to a sudden motion of a user, the degree to which the cable magnet 14 is pressed by the holder head 152 decreases, and the damage or breakage of the cable magnet 14 may decrease.

According to an example embodiment, a wearable exercise device may include a proximal wearing member worn on a proximal part of a user, a distal wearing member worn on a distal part of the user, an actuator including a motor, a level guide shaft, a level guide body, and a spool, in which the motor is disposed in the proximal wearing member and configured to generate power, the level guide shaft is rotated by the motor, the level guide body is connected to the level guide shaft, and the spool is provided in parallel to the level guide shaft, a cable that is at least partially wound around the spool and configured to transmit power generated from the actuator to the distal wearing member, a cable guide that is connected to the proximal wearing member, configured to guide a path of the cable, and may include a plurality of tube magnets in a ring shape, a cable magnet that is connected to the cable and capable of passing through the plurality of tube magnets, and a cable holder that is connected to the distal wearing member, supports the cable magnet, and configured to apply magnetic force to the cable magnet. In an embodiment, a position of the cable wound around the spool changes in a direction parallel to a rotation axis direction of the spool, and the cable is provided to be bent in different directions a plurality of times.

In an embodiment, the actuator may further include a level guide groove recessed from a surface of the level guide groove, and the level guide body may move in a rotation axis direction of the level guide shaft along the level guide groove.

In an embodiment, the actuator may further include a screw contacting at least a portion of the cable extending from the level guide body.

In an embodiment, the screw may include a screw shaft that rotates by receiving power from the level guide shaft, a clutch that surrounds the screw shaft and is configured to transmit power in one direction around the screw shaft, a screw body that surrounds the clutch, an upper thread and a lower thread formed on a surface of the screw body, and a core groove formed between the upper thread and the lower thread.

In an embodiment, a cable seated in the core groove may move in a direction intersecting a rotation axis of the screw body.

In an embodiment, when the screw body rotates, the upper thread and the lower thread may guide the cable to be seated in the core groove.

In an embodiment, a gap between adjacent tube magnets among the plurality of tube magnets decreases as it gets closer to the distal wearing member based on a traveling direction of the cable.

In an embodiment, when the cable magnet is positioned between the plurality of tube magnets, based on a traveling direction of the cable, magnetic force applied to the cable magnet by a tube magnet disposed between the cable magnet and the distal wearing member may be greater than the magnetic force applied to the cable magnet by a tube magnet disposed between the cable magnet and the proximal wearing member.

In an embodiment, the cable holder may include a holder body connected to the distal wearing member, a holder head that extends from the holder body and is configured to seat the cable magnet, a holder groove that is recessed in the holder head and passable by the cable, and a holder magnet that is disposed in the holder head and configured to apply magnetic force to the cable magnet.

In an embodiment, the wearable exercise device may further include a cap that is supported by the holder head and disposed between the holder magnet and the cable magnet.

In an embodiment, the cap may be formed of an elastic material.

In an embodiment, the cable guide may further include a cable tube that surrounds at least a portion of the cable and has the plurality of tube magnets disposed therein, a connector configured to connect one end of the cable tube to the actuator, and a cable chain configured to form a path of the cable tube.

In an embodiment, the cable chain may include a pair of rotation links and a link bearing configured to connect the pair of rotation links, and the pair of rotation links may be rotatable around each other.

In an embodiment, the cable chain may further include an end cover that is connected to the other end of the cable tube and configured to cover at least a portion of a cable from the cable tube.

In an embodiment, the end cover may include a cover body having a structure whose cross-sectional area increases as it moves away from the cable tube and a ring part that reduces friction between the cable and the cover body.

According to another embodiment, a wearable exercise device may include a proximal wearing member worn on a proximal part of a user, a distal wearing member worn on a distal part of the user, an actuator including a motor, a level guide shaft, a level guide body, a spool, and a level guide groove, in which the motor is disposed in the proximal wearing member and configured to generate power, the level guide shaft is rotated by the motor, the level guide body is connected to the level guide shaft, the spool is provided in parallel to the level guide shaft, and the level guide groove recessed from a surface of the level guide groove, and a cable that is at least partially wound around the spool and configured to transmit power generated from the actuator to the distal wearing member. A position of the cable wound around the spool changes in a direction parallel to a rotation axis direction of the spool, and the level guide body is movable in a rotation axis direction of the level guide shaft along the level guide groove.

In an embodiment, the actuator may further include a screw contacting at least a portion of the cable extending from the level guide body.

In an embodiment, the screw may include a screw shaft that rotates by receiving power from the level guide shaft, a clutch that surrounds the screw shaft and is configured to transmit power in one direction around the screw shaft, a screw body that surrounds the clutch, an upper thread and a lower thread formed on a surface of the screw body, and a core groove formed between the upper thread and the lower thread.

In an embodiment, when the screw body rotates, the upper thread and the lower thread may guide the cable to be seated in the core groove.

According to another embodiment, a wearable exercise device may include a proximal wearing member worn on a proximal part of a user, a distal wearing member worn on a distal part of the user, an actuator including a motor, a level guide shaft, a level guide body, and a spool, wherein the motor is disposed in the proximal wearing member and configured to generate power, the level guide shaft is rotated by the motor, the level guide body is connected to the level guide shaft, and the spool is provided in parallel to the level guide shaft, a cable that is at least partially wound around the spool and configured to transmit power generated from the actuator to the distal wearing member, a plurality of tube magnets that is connected to the proximal wearing member, is configured to guide a path of the cable, and has a ring shape and a cable guide that surrounds at least a portion of the cable and may include a cable tube where the plurality of tube magnets is disposed, and a cable magnet that is connected to the cable and capable of passing through the plurality of tube magnets. In an embodiment, a gap between adjacent tube magnets among the plurality of tube magnets decreases as it gets closer to the distal wearing member based on a traveling direction of the cable.

According to another aspect, there is provided a wearable exercise device including a proximal wearing member worn on a proximal part of a user, a distal wearing member worn on a distal part of the user, an actuator including a motor, a level guide shaft, a level guide body, and a spool, in which the motor is disposed in the proximal wearing member and configured to generate power, the level guide shaft is rotated by the motor, the level guide body is connected to the level guide shaft, and the spool is provided in parallel to the level guide shaft, a cable that is at least partially wound around the spool and configured to transmit power generated from the actuator to the distal wearing member, a cable magnet that is connected to the cable, a holder body that supports the cable magnet and is connected to the distal wearing member, a holder head that extends from the holder body and is configured to seat the cable magnet, a holder groove that is recessed in the holder head and passable by the cable, and a holder magnet that is disposed in the holder head and configured to apply magnetic force to the cable magnet.

According to another aspect, there is provided a wearable exercise device including a proximal wearing member worn on a proximal part of a user, a distal wearing member worn on a distal part of the user, an actuator including a motor, a level guide shaft, a level guide body, and a spool, in which the motor is disposed in the proximal wearing member and configured to generate power, the level guide shaft is rotated by the motor, the level guide body is connected to the level guide shaft, and the spool is provided in parallel to the level guide shaft, a cable that is at least partially wound around the spool and configured to transmit power generated from the actuator to the distal wearing member, and a cable tube that is connected to the proximal wearing member, is configured to guide a path of the cable, and surrounds at least a portion of the cable, and a cable guide including a cable chain configured to form a path of the cable tube. In an embodiment, the cable chain may include a pair of rotation links and a link bearing configured to connect the pair of rotation links, in which the pair of rotation links are rotatable around each other, and the cable is provided to be bent in different directions a plurality of times.

Each embodiment herein may be used in combination with any other embodiment(s) described herein.

In an embodiment, the features of the above-described embodiments may be combined unless clearly technically impossible.

A number of embodiments have been described above. Nevertheless, it should be understood that various modifications may be made to these embodiments. Suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A wearable exercise device comprising:
a proximal wearing member, comprising a support, configured to be worn on a proximal part of a user;
a distal wearing member, comprising a support, configured to be worn on a distal part of the user;
an actuator comprising a motor, a level guide shaft, a level guide body, and a spool, wherein the motor is at least partially disposed in the proximal wearing member and configured to generate power, the level guide shaft is configured to be rotated by the motor, the level guide body is connected to the level guide shaft, and the spool is provided substantially in parallel to the level guide shaft;
a cable at least partially wound around the spool and configured to transmit power generated from the actuator to the distal wearing member;
a cable guide connected to the actuator, configured to guide a path of the cable, and comprising a plurality of tube magnets in substantially a ring shape;
a cable magnet connected to the cable and capable of passing through the plurality of tube magnets; and
a cable holder connected to the distal wearing member, for supporting the cable magnet, and configured to apply magnetic force to the cable magnet,
wherein the device is configured so that a position of the cable wound around the spool is configured to change in a direction parallel to a rotation axis direction of the spool, and
wherein the cable is configured to be bent in different directions a plurality of times.

2. The wearable exercise device of claim 1, wherein the actuator further comprises a level guide groove recessed from a surface of the level guide shaft, and
the level guide body is configured to be movable in a rotation axis direction of the level guide shaft along the level guide groove.

3. The wearable exercise device of claim 1, wherein the actuator further comprises a screw contacting at least a portion of the cable extending from the level guide body.

4. The wearable exercise device of claim 3, wherein the screw comprises:
a screw shaft configured to rotate by receiving power from the level guide shaft;
a clutch that surrounds the screw shaft and is configured to transmit power in a direction around the screw shaft;
a screw body that at least partially surrounds the clutch;
an upper thread and a lower thread on a surface of the screw body; and
a core groove formed between at least the upper thread and the lower thread.

5. The wearable exercise device of claim 4, wherein a cable seated in the core groove is configured to move in a direction intersecting a rotation axis of the screw body.

6. The wearable exercise device of claim 4, wherein the device is configured so that, when the screw body rotates, the upper thread and the lower thread are configured to guide the cable to be seated in the core groove.

7. The wearable exercise device of claim 1, wherein a gap between adjacent tube magnets among the plurality of tube magnets decreases as it gets closer to the distal wearing member based on a traveling direction of the cable.

8. The wearable exercise device of claim 1, wherein the device is configured so that, when the cable magnet is positioned between the plurality of tube magnets,
based on a traveling direction of the cable, magnetic force applied to the cable magnet by a tube magnet disposed between the cable magnet and the distal wearing member is greater than magnetic force applied to the cable magnet by a tube magnet disposed between the cable magnet and the proximal wearing member.

9. The wearable exercise device of claim 1, wherein the cable holder comprises:
a holder body connected to the distal wearing member;
a holder head that extends from the holder body and is configured to seat the cable magnet;
a holder groove that is recessed in the holder head and passable by the cable; and
a holder magnet disposed in the holder head and configured to apply magnetic force to the cable magnet.

10. The wearable exercise device of claim 9, further comprising:
a cap supported by the holder head and disposed between at least the holder magnet and the cable magnet.

11. The wearable exercise device of claim 10, wherein the cap comprises an elastic material.

12. The wearable exercise device of claim 1, wherein the cable guide further comprises:
a cable tube that surrounds at least a portion of the cable and has the plurality of tube magnets disposed therein;
a connector configured to connect an end of the cable tube to the actuator; and
a cable chain configured to form a path of the cable tube.

13. The wearable exercise device of claim 12, wherein the cable chain comprises a pair of rotation links and a link bearing configured to connect the pair of rotation links,
wherein the pair of rotation links are configured to be rotatable around each other.

14. The wearable exercise device of claim 13, wherein the cable chain further comprises an end cover that is connected to the other end of the cable tube and is configured to cover at least a portion of a cable from the cable tube.

15. The wearable exercise device of claim 14, wherein the end cover comprises:
a cover body including a portion whose cross-sectional area increases moving away from the cable tube; and
a ring part configured to reduce friction between the cable and the cover body.

16. A wearable exercise device comprising:
a proximal wearing member, comprising a support, configured to be worn on a proximal part of a user;
a distal wearing member, comprising a support, configured to be worn on a distal part of the user;
an actuator comprising a motor, a level guide shaft, a level guide body, a spool, and a level guide groove, wherein the motor is disposed at least partially in the proximal wearing member and is configured to generate power, the level guide shaft is configured to be rotated by the motor, the level guide body is connected to the level guide shaft, the spool is provided substantially parallel to the level guide shaft, and the level guide groove is recessed; and
a cable that is at least partially wound around the spool and configured to transmit power generated from the actuator to the distal wearing member,
wherein the device is configured so that a position of the cable wound around the spool changes in a direction parallel to a rotation axis direction of the spool, and
the level guide body is configured to be movable in a rotation axis direction of the level guide shaft along the level guide groove.

17. The wearable exercise device of claim 16, wherein the actuator further comprises a screw contacting at least a portion of the cable extending from the level guide body.

18. The wearable exercise device of claim 17, wherein the screw comprises:
a screw shaft configured to rotate by receiving power from the level guide shaft;
a clutch that surrounds the screw shaft and is configured to transmit power in a direction around the screw shaft;
a screw body that at least partially surrounds the clutch;
an upper thread and a lower thread on a surface of the screw body; and
a core groove formed between at least the upper thread and the lower thread.

19. The wearable exercise device of claim 18, wherein the device is configured so that, when the screw body rotates, the upper thread and the lower thread are configured to guide the cable to be seated in the core groove.

20. A wearable exercise device comprising:
a proximal wearing member, comprising a support, configured to be worn on a proximal part of a user;
a distal wearing member, comprising a support, configured to be worn on a distal part of the user;
an actuator comprising a motor, a level guide shaft, a level guide body, and a spool, wherein the motor is configured to be disposed in the proximal wearing member and configured to generate power, the level guide shaft is configured to be rotated by the motor, the level guide body is connected to the level guide shaft, and the spool is provided in parallel to the level guide shaft;
a cable at least partially wound around the spool and configured to transmit power generated from the actuator to the distal wearing member;
a plurality of tube magnets connected to the proximal wearing member, and configured to guide a path of the cable, and comprising a ring shape and a cable guide that surrounds at least a portion of the cable and comprises a cable tube where the plurality of tube magnets is disposed; and
a cable magnet connected to the cable and configured for passing through the plurality of tube magnets,
wherein the device is configured so that a gap between adjacent tube magnets among the plurality of tube magnets decreases as it gets closer to the distal wearing member based on a traveling direction of the cable.
